(19) United States
(12) Patent Application Publication
(10) Pub. No.: US 2024/0265938 A1
(43) Pub. Date: Aug. 8, 2024

(54) ANNOTATION REQUESTING DEVICE, ANNOTATION REQUESTING METHOD, AND STORAGE MEDIUM

(71) Applicant: TOYOTA JIDOSHA KABUSHIKI KAISHA, Toyota-shi (JP)

(72) Inventor: Yasuhiro Kobayashi, Tokyo (JP)

(21) Appl. No.: 18/433,492

(22) Filed: Feb. 6, 2024

(30) Foreign Application Priority Data
Feb. 7, 2023 (JP) 2023-017206

(51) Int. Cl. G10L 25/63

(52) U.S. Cl. CPC G10L 25/63

(57) ABSTRACT

An annotation requesting device is provided, which includes a memory and a processor coupled to the memory, the processor being configured to estimate emotions of a speaker, including positive and negative emotions, from audio data, and, in a case in which an estimated emotion is positioned within a predetermined range of a positive threshold or a negative threshold, make a request for annotation by presenting, to an annotator, each of audio data of the speaker and other audio data that has been estimated or annotated and that is positioned within the predetermined range.

### CROSS-REFERENCE TO RELATED APPLICATION

This application is based on and claims priority under 35 USC 119 from Japanese Patent Application No. 2023-017206, filed on Feb. 7, 2023, the disclosure of which is incorporated by reference herein.

### BACKGROUND

### Technical Field

The present disclosure relates to an annotation requesting device, an annotation requesting method, and a non-transitory storage medium storing an annotation requesting program.

### Related Art

Japanese Patent Application Laid-Open (JP-A) No. 2019-179372 proposes a learning (or training) data creation method for creating learning data for risk prediction using a computer, in which the learning data includes positive data and negative data.

More specifically, plural pieces of still image data or moving image data are acquired as plural pieces of event data that each reflect an event, which is an accident or an incident, and plural pieces of non-event data that each do not reflect an event. First data, which is still image data or moving image data that is included in one piece of event data from among the acquired plural pieces of event data, and which is still image data or moving image data that is of a predetermined amount of time prior to an event, is presented. One piece of non-event data from among the acquired plural pieces of non-event data is presented as second data. Learning data is created by receiving a determination result with respect to whether or not the first data and the second data are similar to each other, and storing the event data and the non-event data in a storage device. At the time of storage, the event data is stored as positive data, the non-event data is stored as positive data in a case in which the received determination result indicates that the first data and the second data are similar to each other, and the non-event data is stored as negative data in a case in which the received determination result indicates that the first data and the second data are not similar to each other.

Although the technology of JP-A No. 2019-179372 is applicable not only to determination of event data and non-event data, but also, for example, to estimation of an emotion of a speaker, there is room for improvement because two types of data are uniformly presented to an annotator, resulting in an increase in a load on the annotator.

### SUMMARY

The present disclosure has been made in consideration of the above, and provides an annotation requesting device, an annotation requesting method, and a non-transitory storage medium storing an annotation requesting program that are capable of reducing a load on an annotator.

An annotation requesting device according to a first aspect includes an estimation section configured to estimate emotions of a speaker, including positive and negative emotions, from audio data, and a requesting section configured to, in a case in which an emotion that has been estimated by the estimation section is positioned within a predetermined range of a positive threshold or a negative threshold, make a request for annotation by presenting, to an annotator, each of audio data of the speaker and other audio data that has been estimated or annotated and that is positioned within the predetermined range.

According to the first aspect, emotions of the speaker, including positive and negative, are estimated by the estimation section, from audio data.

In a case in which an emotion that has been estimated by the estimation section is positioned within the predetermined range of the positive or negative threshold, annotation is requested by the requesting section by presenting, to the annotator, each of the audio data of the speaker and the other audio data that has been estimated or annotated and that is positioned within the predetermined range. Consequently, since audio data in the vicinity of the threshold is presented to the annotator to make the annotation request, a load on the annotator may be reduced more than in a case in which two types of data, which are positive data and negative data, are presented uniformly.

An annotation requesting device according to a second aspect is the annotation requesting device according to the first aspect, wherein the requesting section presents, as the other audio data, two pieces of audio data that straddle (or position above and below) the threshold.

According to the second aspect, by presenting the two pieces of audio data that straddle the threshold, as other audio data, it is possible to carry out the annotation more accurately than by transmitting audio data that does not straddle the threshold.

An annotation requesting method according to a third aspect includes performing processing by a computer, in which the processing includes estimating emotions of a speaker, including positive and negative emotions, from audio data, and, in a case in which an estimated emotion is positioned within a predetermined range of a positive threshold or a negative threshold, making a request for annotation by presenting, to an annotator, each of audio data of the speaker and other audio data that has been estimated or annotated and that is positioned within the predetermined range.

According to the third aspect, an annotation requesting method capable of reducing a load on an annotator may be provided.

A non-transitory recording medium according to a fourth aspect stores a program that is executable by a computer to perform annotation requesting processing, in which the annotation requesting processing includes estimating emotions of a speaker, including positive and negative emotions, from audio data, and, in a case in which an estimated emotion is positioned within a predetermined range of a positive threshold or a negative threshold, making a request for annotation by presenting, to an annotator, each of audio data of the speaker and other audio data that has been estimated or annotated and that is positioned within the predetermined range.

According to the fourth aspect, a non-transitory storage medium storing an annotation requesting program of capable of reducing a load on an annotator may be provided.

As described above, according to the present disclosure, an annotation requesting device, an annotation requesting method, and a non-transitory storage medium that are capable of reducing a load on an annotator may be provided.

### BRIEF DESCRIPTION OF THE DRAWINGS

FIG. 1 is a diagram illustrating a schematic configuration of an information processing system according to the present exemplary embodiment.

FIG. 2 is a block diagram illustrating a schematic configuration of a server of the information processing system according to the present exemplary embodiment.

FIG. 3 is a flowchart illustrating an example of a flow of processing performed by an annotation requesting section of the server of the information processing system according to the present exemplary embodiment.

FIG. 4 is a flowchart illustrating an example of a flow of processing performed by an emotion value estimation model training section of the server of the information processing system according to the present exemplary embodiment.

### DETAILED DESCRIPTION

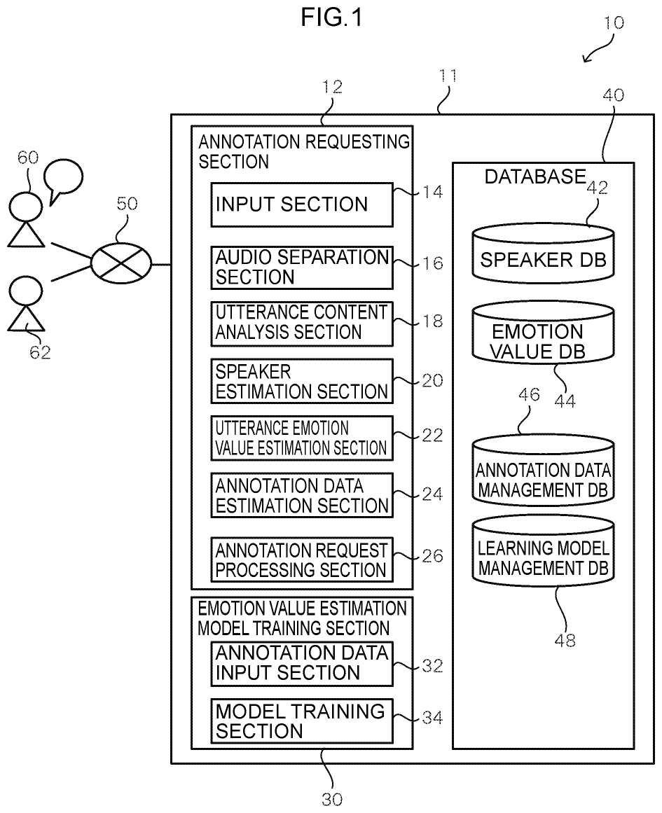

Below, an exemplary embodiment of the present disclosure will be explained in detail with reference to the drawings. An information processing system including an annotation requesting device will be explained. FIG. 1 is a diagram illustrating a schematic configuration of the information processing system according to the present exemplary embodiment.

The information processing system 10 according to the present exemplary embodiment is a system that makes a request to an annotator 62 for annotation of audio data used in learning of a machine learning model that estimates an emotion of a speaker 60 from audio of a conversation.

The information processing system 10 according to the present exemplary embodiment includes a server 11 that is connected to a network 50 such as a local area network (LAN), the internet or the like, and the server 11 functions as an annotation requesting device as an example.

The server 11 receives audio data in which audio of the speaker 60 is recorded, via the network 50, and performs processing to make a request for annotation to the annotator 62 via the network 50. Further, the server 11 performs processing such as receiving an annotation result from the annotator 62 via the network 50 to learn the machine learning model that estimates the emotion of the speaker 60.

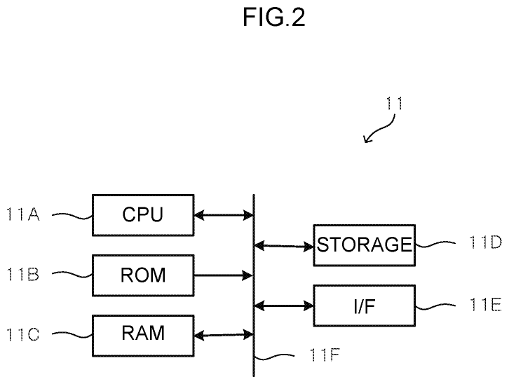

As illustrated in FIG. 2, the server 11 is configured by a general computer including a central processing unit (CPU) 11A, a read only memory (ROM) 11B, a random access memory (RAM) 11C, a storage 11D, an interface (I/F) 11E, a bus 11F, and the like. The CPU 11A loads in the RAM 11C and executes a program such as an annotation requesting program or the like, which is stored in the ROM 11B, to thereby function as an annotation requesting section 12, an emotion value estimation model training section 30, and a database (DB) 40. It should be noted that FIG. 2 is a block diagram illustrating a schematic configuration of the server 11 of the information processing system 10 according to the present exemplary embodiment.

As illustrated in FIG. 1, the annotation requesting section 12 includes functionality of an input section 14, an audio separation section 16, an utterance content analysis section 18, a speaker estimation section 20, an utterance emotion value estimation section 22 serving as an example of an estimation section, an annotation data estimation section 24, and an annotation request processing section 26 serving as an example of a requesting section.

The input section 14 receives, as audio data, audio information including only audio, or video information including audio, which has been acquired from, for example, a cloud type server or an on-premises type server. For example, audio data in which the speaker 60 has been recorded is transmitted from an information processing terminal such as a personal computer or the like to the server 11, and this is received by the input section 14.

In a case in which the audio data that has been acquired by the input section 14 is video information including audio, the audio separation section 16 performs processing to separate the audio information and the video information and extract only the audio information as the audio data.

The utterance content analysis section 18 performs transcription based on the audio data that has been extracted by the audio separation section 16. In a case in which the input section 14 has received audio information including only audio as the audio data, the utterance content analysis section 18 executes transcription based on the audio data that has been received by the input section 14. For example, a known technique for transcribing from audio is used to perform the transcription from the audio data. As such a known technique, a learning model that estimates characters from audio is generated by machine learning, and transcription is performed by inputting the audio data to the learning model.

The speaker estimation section 20 performs processing to compare with a past speaker DB 42 and estimate the speaker 60. For example, a method of specifying the speaker 60 of the audio data by a technique for specifying an individual, such as voice print authentication or the like, is used.

The utterance emotion value estimation section 22 performs processing to estimate an emotion value, an intonation, a speaking speed, and the like of the audio data. For example, a learning model that estimates an emotion value, an intonation, a speaking speed, and the like from audio data is generated by machine learning, and the emotion value, the intonation, the speaking speed, and the like are estimated by inputting the audio data to the learning model. In the present exemplary embodiment, the utterance emotion value estimation section 22 estimates the emotion value of the speaker 60 using a learning model that has been learned by machine learning. As an example of the emotion value, a value of 0 to 100 is used.

The annotation data estimation section 24 checks the emotion values that have been estimated by the utterance emotion value estimation section 22, and performs processing to extract values in the vicinity of a positive or negative threshold. For example, the emotion value is designated as a value of 0 to 100, with 0 to 30 being designated as negative, 70 to 100 being designated as positive, and 31 to 69 being designated as normal. Further, as an example of the vicinity of the threshold, values above and below (for example, 5% above and below, or the like) within a predetermined range of the threshold (for example, 30 or 70) are applied, and values in the vicinity of the threshold are extracted from the emotion values that have been estimated by the utterance emotion value estimation section 22.

In a case in which the annotation data estimation section 24 has been able to extract data in the vicinity of the threshold, that is to say, in a case in which the data is positioned within the predetermined range of the positive or negative threshold, the annotation request processing section 26 performs processing to request annotation by transmitting, to the annotator 62, a total of three items, which are the audio data corresponding to values (two values above and below) in the vicinity of the threshold held until immediately before and the input audio. It should be noted that, in the present exemplary embodiment, three pieces of data, which are the audio data corresponding to the values (two values above and below) in the vicinity of the threshold held until immediately before and the input audio, are transmitted to the annotator 62. However, there is no limitation thereto, and the audio data in the vicinity of the threshold may be only one of the values above and below within the predetermined range of the threshold. Further, the values in the vicinity of the threshold may be audio data for which the emotion value has been estimated by the learning model, or may be audio data that has been annotated. Furthermore, the data is transmitted to the annotator 62 by, for example, transmitting the data to an information processing terminal such as a personal computer or the like that is operated by the annotator 62.

Further, the emotion value estimation model training section 30 has functionality of an annotation data input section 32 and a model training section 34.

The annotation data input section 32 receives an annotation result for the audio data for which a request has been made to the annotator 62 from the annotation request processing section 26.

The model training section 34 performs training processing to the learning model that estimates the emotion value, using the annotation result that has been received by the annotation data input section 32. For example, using the annotation result that has been received by the annotation data input section 32, threshold updating is carried out by ranking learning or the like.

Meanwhile, the database 40 includes the speaker DB 42, an emotion value DB 44, an annotation data management DB 46, a learning model management DB 48, and the like.

The speaker DB 42 generates a speaker DB from past audio data, and is used at a time of estimation of the speaker 60.

The emotion value DB 44 manages emotion values of respective utterances as a database. For example, the emotion value DB 44 manages data including emotion values, intonations, speaking speeds, and the like that have been estimated by the utterance emotion value estimation section 22.

The annotation data management DB 46 manages annotation results of past audio data by including the annotation results in the audio data.

The learning model management DB 48 uses audio data as input values to manage the learning model that estimates the emotion values of utterances. For example, the learning model management DB 48 manages the learning model that has been trained by the model training section 34.

Next, concrete processing performed by the server 11 of the information processing system 10 according to the present exemplary embodiment configured as described above will be explained.

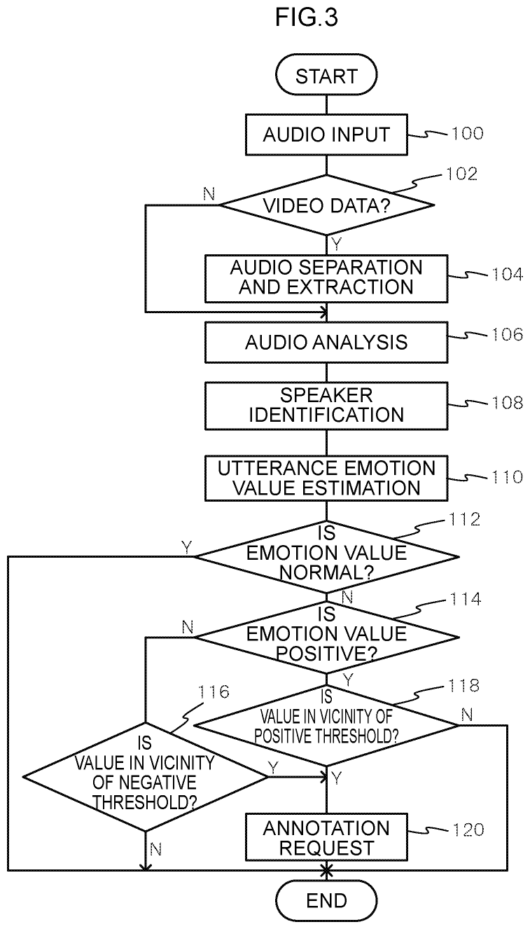

First, processing performed by the annotation requesting section 12 of the server 11 of the information processing system 10 according to the present exemplary embodiment will be explained. FIG. 3 is a flowchart illustrating an example of a flow of processing performed by the annotation requesting section 12 of the server 11 of the information processing system 10 according to the present exemplary embodiment. It should be noted that the processing of FIG. 3 is started in a case in which, for example, an annotation request for audio data has been instructed.

At step 100, the CPU 11A performs audio input, and transitions to step 102. Namely, the input section 14 receives the audio information or the video information including audio that has been acquired from, for example, a cloud type server or an on-premises type server, as audio data.

At step 102, the CPU 11A determines whether or not the data is video data. The determination is made as to whether or not the audio data that has been received by the input section 14 is video information including audio. In a case in which the determination is affirmative, the processing transitions to step 104, while in a case in which there is only audio information, the determination is negative, and the processing transitions to step 106.

At step 104, the CPU 11A separates and extracts audio, and transitions to step 106. Namely, in a case in which the audio data that has been acquired by the input section 14 is video information including audio, the audio separation section 16 performs processing to separate the audio information and the video information and extract only the audio information as audio data.

At step 106, the CPU 11A performs audio analysis of the audio data, and transitions to step 108. Namely, the utterance content analysis section 18 performs transcription based on the audio data that has been extracted by the audio separation section 16 or the audio data of the audio information including only audio that has been received by the input section 14.

At step 108, the CPU 11A identifies the speaker 60, and transitions to step 110. Namely, the speaker estimation section 20 performs processing to compare with the past speaker DB 42 and estimate the speaker 60.

At step 110, the CPU 11A estimates the utterance emotion value, and transitions to step 112. Namely, the utterance emotion value estimation section 22 performs processing to estimate an emotion value of the audio data using the learning model that has been generated by machine learning.

At step 112, the CPU 11A determines whether or not the estimated emotion value is normal. In the present exemplary embodiment, in this determination, the annotation data estimation section 24 checks the emotion value that has been estimated by the utterance emotion value estimation section 22 to determine whether or not the estimated emotion value is, for example, a value of 31 to 69. In a case in which the determination is affirmative, the series of processing is ended, and in a case in which the determination is negative, the processing transitions to step 114.

At step 114, the CPU 11A determines whether or not the emotion value is positive. In the present exemplary embodiment, in this determination, the annotation data estimation section 24 checks the emotion value that has been estimated by the utterance emotion value estimation section 22 to determine whether or not the estimated emotion value is, for example, a value of 70 to 100. In a case in which the determination is negative, namely, in a case in which the emotion value is from 0 to 30, the negative determination is made, and the processing transitions to step 116. In a case in which the determination is affirmative, the processing transitions to step 118.

At step 116, the CPU 11A determines whether or not the value is in the vicinity of the negative threshold. In the present exemplary embodiment, in this determination, the annotation data estimation section 24 checks the emotion value that has been estimated by the utterance emotion value estimation section 22 to determine, for example, whether or not the value is above or below within the predetermined range of the negative threshold, as a value in the vicinity of the negative threshold. In a case in which the determination is negative, the series of processing is ended, and in a case in which the determination is affirmative, the processing transitions to step 120.

At step 118, the CPU 11A determines whether or not the value is in the vicinity of the positive threshold. In the present exemplary embodiment, in this determination, the annotation data estimation section 24 checks the emotion value that has been estimated by the utterance emotion value estimation section 22 to determine, for example, whether or not the value is above or below within the predetermined range of the positive threshold, as a value in the vicinity of the positive threshold. In a case in which the determination is negative, the series of processing is ended, and in a case in which the determination is affirmative, the processing transitions to step 120.

At step 120, the CPU 11A carries out the annotation request and ends the series of processing. Namely, in a case in which the annotation data estimation section 24 has been able to extract data in the vicinity of the threshold, the annotation request processing section 26 performs processing to request annotation by transmitting, to the annotator 62, a total of three items, which are the values (two values above and below) in the vicinity of the threshold held until immediately before and the input audio.

As described above, in the server 11 of the information processing system 10 according to the present exemplary embodiment, an annotation request is made to the annotator 62 for the audio data in the vicinity of the threshold, and therefore, a load on the annotator 62 may be reduced more than in a case in which two types of data, which are positive data and negative data, are presented uniformly.

Further, since the audio data corresponding to the values above and below within the predetermined range of the threshold and the input audio are transmitted to the annotator 62, it is possible to have that which is thought to be more positive or negative be selected. Consequently, the degree of positivity or negativity may be calculated by ranking learning or the like, and data (hard examples, threshold boundaries, or the like) effective for the model may be presented to a user.

Further, at the time of requesting annotation, since audio data corresponding to the values above and below straddling the threshold is transmitted as the audio data in the vicinity of the threshold, the width above and below within the predetermined range of the threshold may be presented to the annotator 62, and it is possible to carry out the annotation more accurately than by transmitting other audio data that does not straddle the threshold.

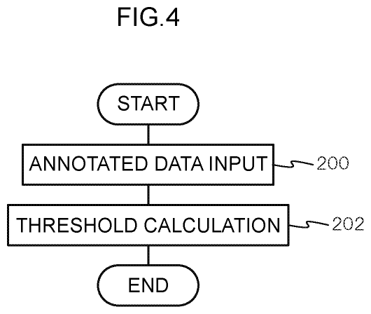

Next, processing performed by the emotion value estimation model training section 30 of the server 11 of the information processing system 10 according to the present exemplary embodiment will be explained. FIG. 4 is a flowchart illustrating an example of a flow of processing performed by the emotion value estimation model training section 30 of the server 11 of the information processing system 10 according to the present exemplary embodiment. It should be noted that the processing of FIG. 4 is started, for example, in a case in which an annotation result has been received from the annotator 62.

At step 200, the CPU 11A inputs the annotated data, and transitions to step 202. Namely, the annotation data input section 32 receives the annotation result for the audio data for which a request was made to the annotator 62 from the annotation request processing section 26.

At step 202, the CPU 11A performs positive or negative threshold calculation, and ends the series of processing. For example, the model training section 34 uses the annotation result that has been received by the annotation data input section 32 to perform threshold updating by ranking learning or the like. Namely, the threshold for estimating the emotion value is recalculated by performing processing to re-train the learning model that estimates the emotion value. Consequently, the accuracy of estimating the emotion value of the re-trained learning model may be improved.

It should be noted that, although the annotation requesting section 12, the emotion value estimation model training section 30, and the database 40 have been explained as functionality of the same server 11 in the above-described exemplary embodiment, there is no limitation thereto. For example, the respective functions may belong to different servers, or any one of the functions may be a function that belongs to a different server.

Further, although the processing that is performed by the server 11 in the above-described exemplary embodiment has been explained as software processing that is performed by executing a program, there is no limitation thereto. For example, the processing may be performed using hardware such as a graphics processing unit (GPU), an application specific integrated circuit (ASIC), a field-programmable gate array (FPGA) or the like. Alternatively, the processing may be performed by a combination of both software and hardware. In a case in which software processing is employed, the programs may be stored and distributed on various storage media.

Moreover, the present disclosure is not limited to that which is described above, and it is obvious that, aside from what is described above, various other modifications may also be implemented within a range that does not depart from the spirit of the present disclosure.

What is claimed is:

1. An annotation requesting device comprising:
a memory; and
a processor coupled to the memory, the processor being configured to:
estimate emotions of a speaker, including positive and negative emotions, from audio data, and
in a case in which an estimated emotion is positioned within a predetermined range of a positive threshold or a negative threshold, make a request for annotation by presenting, to an annotator, each of audio data of the speaker, and other audio data that has been estimated or annotated and that is positioned within the predetermined range.

2. The annotation requesting device according to claim 1, wherein the processor is configured to present, as the other audio data, two pieces of audio data that position above and below the threshold.

3. An annotation requesting method comprising performing processing by a computer, the processing comprising:
estimating emotions of a speaker, including positive and negative emotions, from audio data, and
in a case in which an estimated emotion is positioned within a predetermined range of a positive threshold or a negative threshold, making a request for annotation by presenting, to an annotator, each of audio data of the speaker and other audio data that has been estimated or annotated and that is positioned within the predetermined range.

4. A non-transitory storage medium storing a program that is executable by a computer to perform annotation requesting processing, the annotation requesting processing comprising:
estimating emotions of a speaker, including positive and negative emotions, from audio data, and
in a case in which an estimated emotion is positioned within a predetermined range of a positive threshold or a negative threshold, making a request for annotation by presenting, to an annotator, each of audio data of the speaker and other audio data that has been estimated or annotated and that is positioned within the predetermined range.
